(19) United States
(12) Patent Application Publication
(10) Pub. No.: US 2016/0208840 A1
(43) Pub. Date: Jul. 21, 2016

(54) Fastener With Removable Head End

(71) Applicant: Matthew Neber, Homestead, FL (US)

(72) Inventor: Matthew Neber, Homestead, FL (US)

(21) Appl. No.: 14/992,440

(22) Filed: Jan. 11, 2016

Related U.S. Application Data
(60) Provisional application No. 62/104,238, filed on Jan. 16, 2015.

(51) Int. Cl. F16B 23/00

(52) U.S. Cl. CPC F16B 23/00; F16B 23/0015; F16B 23/003; F16B 23/0038

(57) ABSTRACT

A fastener having a threaded or screw-type shad with a tool receptacle accepting end section, and a removable head end similarly having a tool receptacle accepting section, with the threaded shaft designed to accept a retaining element or nut, is disclosed. In operation, upon assembly, the fastener may be released from one side without access to the retaining element. In one embodiment, the fastener has a threaded shaft with a tool receptacle feature for engaging or gripping, with one end of the threaded shaft having a reducing end feature for indexing into an annular, nut-like, low profile threaded head with a tool receptacle feature that further allows access to the indexed screw shaft. Upon assembly, the invention resembles a normal screw or boll with a widened head to rest on a surface around a hole and an elongated threaded shaft that can accept a nut.

### CLAIM OF PRIORITY

This application claims the benefit of priority under 35 U.S.C. §119(e) from U.S. Provisional Patent Application Ser. No. 62/104,238, filed on Jan. 16, 2015, the benefit of priority of which is claimed hereby, and the contents of which are incorporated by reference herein in its entirety as if set forth in full.

### FIELD OF THE INVENTION

The present invention generally relates to fastener devices, and more specifically relates to fasteners that are threaded or at least partially threaded, and have a removable head end such that the fastener can be readily assembled and disassembled through use of one or more tools solely from one end of the fastener. In one embodiment, the threaded fastener shaft or barrel is designed to accept different configuration head ends, or allow interchangeable head ends, and thereby provide greater flexibility and utility of the fastener.

### BACKGROUND OF THE INVENTION

Screw or bolt type fasteners having at least partially threaded shaft or barrel sections and counterpart or associated nut ends are used widely in many assemblies for both small and large construction. Indeed, such threaded and partially threaded fasteners are manufactured and commercialized in many different sizes, diameters, and lengths, for use in a multitude of applications.

When a typical nut and holt fastener is normally assembled or disassembled a tool is used to grip the nut and bolt separately, individually and at the distinct ends of the fastener. Certain uses of such Fasteners, and assemblies that incorporate such fasteners, require or result in configurations and installations where, after assembly, there may be no or very restricted access to the nut end that would allow for disassembly of the fastener. For example, where nut and bolt fasteners are used to position and retain a door, hatch or platform assembly that is operated remotely by an electromechanical actuator, in one or more positions the door, hatch or platform may close off access to a cavity housing said actuator. In the event that the actuator fails in the “closed” position, then access to the cavity to repair or replace the actuator may be difficult or impossible. Another example includes pre-rig assemblies and subassemblies where mounted hardware is positioned such that no access to the nut is permitted once the final product is completed.

In those situations where access to either the nut ambler bolt ends is impossible, disassembly of the fastener is difficult, if not impossible. Moreover, where access to both the head end and nut end of the fastener is not possible to disassemble the fastener, then the only method of disassembly may be destruction of the fastener. Given that fastener nuts, shafts, screws and bolts are required to be resilient and strong by the nature of their work, destructive removal of a fastener is often labor intensive, difficult, costly, messy, and has potential to be harmful, destructive, or hazardous to the surrounding objects, and possibly to the user.

One alternative design that allows for disassembly of a normal fastener from one side requires leaving an excess length of threads above the nut so that the exposed shall end of the fastener may be gripped by a tool while the nut is also separately gripped and then loosened. Manufacturing and using products in such a way is both dangerous and aesthetically displeasing because of the extra length of threaded screw that must be left exposed beyond the nut end. Moreover, such exposed length of the fastener can catch loose objects or harm individuals or objects passing, by the exposed fastener end.

Another example of a multi-piece fastener is disclosed in U.S. Pat. No. 8,555,481, issued to Porter et al. for a Multi-Piece Fastener with Self-Indexing Nut (the “'481 patent”). More particularly, the '481 patent teaches a multi-piece fastener with a self-indexing nut specifically designed for use in low clearance areas such as aircraft wing side-of-body joint locations. Significantly, the '481 patent device is designed only for tightening, or torqueing the fastener. In the '481 patent there is no disclosure of any ability to disassemble the fastener using one or more tools from one side of the fastener.

A further example of a fastener is shown in U.S. Pat. No. 5,647,710, issued to Cushman for a Bolt with Removable Head (the “'710 patent”). The fasteners described in the '710 patent each have two end portions, with each end portion resembling a head end and using Allen wrench drive mechanisms to assemble the fastener. More specifically, the '710 patent disclosures do not show a fastener that can be assembled and disassembled using tools from one end of the fastener.

Accordingly, what is needed in the fastener art is a threaded or partially threaded, screw or bolt-type fastener having a removable head end such that the fastener can be readily assembled and disassembled through use of one or more tools from one end of the fastener. Such devices do not appear to have been fully and specifically designed or used in the relevant prior art.

### SUMMARY OF THE INVENTION

The present invention overcomes the disadvantages of the prior art and fulfills the needs described above by providing a fastener device that is readily able to be assembled and disassembled using one or more tools from one end of the fastener.

A preferred aspect of the invention is a fastener having a removable head end, comprising an at least partially threaded shaft having two ends, wherein a first end has a tool receptacle accepting section, and a second end can accept a retaining element a head end having a hole therein, a tool receptacle accepting section, and a shaft engaging section, such that upon engaging the head end shaft engaging section Onto the first end of the threaded shaft, the shaft tool receptacle accepting section is accessible through the hole; and a retaining clement having a threaded hole therein for engagement and screwing onto the second end of the threaded shaft.

Another preferred aspect of the invention is a fastener having a removable head end, comprising a fully threaded shaft having two ends, wherein a first end has a tool receptacle accepting section, and a second end can accept a retaining element; a head end having a hole therein, and a threaded section, such that upon screwing, the head end threaded section onto the first end of the threaded shaft, the shaft tool receptacle accepting section indexes into, and is accessible through the hole, the head end further having a tool receptacle accepting section; and a retaining element having a threaded hole therein for engagement and screwing onto the second end of the threaded shaft.

A further preferred aspect of the invention is a threaded fastener and tool system, for use in assembling and disassembling a threaded fastener, comprising a threaded shaft having two ends, wherein a first end has a first tool receptacle accepting section, and a second end can accept a retaining element; a head end having a hole therein, and a shaft engaging section, such that upon engaging the head end engaging section onto the first end of the threaded shaft, the shaft tool receptacle accepting section indexes into, and is accessible through the hole, the head end further having a second tool receptacle accepting section; a retaining element having a threaded hole therein for engagement and screwing onto the second end of the threaded shaft; a first tool for applying rotational torque to the threaded shaft via the first tool receptacle accepting section of the threaded shaft and engaging the first tool receptacle accepting section through the hole in the head end; and a second tool for applying rotational torque to the head end via the second tool receptacle accepting section of the head end.

### BRIEF DESCRIPTION OF THE DRAWINGS

For the purposes of illustrating the invention, the attached drawings show several aspects and embodiments that are presently preferred. However, it should be understood that the invention is not limited to the precise arrangement and configuration shown in the accompanying drawings.

FIG. 1: is a side view of an exemplary embodiment of the present inventive fastener having a removable head end and a he end on the threaded shaft;

FIG. 2: is a top view of the exemplary embodiment of the present inventive fastener of

FIG. 3A: is a perspective view of the exemplary embodiment of the present inventive fastener shaft of FIG. 1 showing the hex tool accepting end of the threaded shaft

FIG. 3B: is a side view of the exemplary embodiment of the present inventive fastener shaft of FIG. 1 showing the hex tool accepting end of the threaded shaft;

FIG. 3C: is a top view of the exemplary embodiment of the present inventive fastener shaft of FIG. 1 showing the hex tool accepting end of the threaded shaft;

FIG. 4: is a side view of another exemplary embodiment of the present inventive fastener having a removable head end and a slotted end on the threaded shaft;

FIG. 5: is another side view of the exemplary embodiment of the present inventive Fastener as also shown in FIG. 4;

FIG. 6: is a top view of the exemplary embodiment of the present inventive fastener of FIG. 5 showing the slotted tool accepting end of the threaded shaft;

FIG. 7A: is a perspective view of the exemplary embodiment of the present inventive fastener shaft of FIG. 4 showing the slotted tool accepting end of the threaded shaft;

FIG. 7B: is a side view of the exemplary embodiment of the present inventive fastener shaft of FIG. 4 showing the slotted tool accepting end of the threaded shaft

FIG. 7C: is a top view of the exemplary embodiment of the present inventive fastener shaft of FIG. 4 showing the slotted tool accepting end of the threaded shaft;

FIG. 8A: is a side and bottom view of an exemplary embodiment of the present inventive fastener head end showing the slotted tool accepting feature;

FIG. 8B: is another side and a top view of an exemplary embodiment of the present inventive fastener head end showing the slotted tool accepting end feature;

FIG. 9: are two perspective views of a rendered illustration of an exemplary embodiment of the present inventive fastener head shown in FIGS. 8A. and 8B;

FIG. 10A: is a side view of an exemplary embodiment of the present inventive fastener showing a tapered screw head end assembled on the threaded shaft;

FIG. 10B: is another side view of an exemplary embodiment of the present inventive fastener showing a tapered screw head end assembled on the threaded shaft:

FIG. 10C: is an exploded perspective view of an exemplary embodiment of the present inventive fastener showing a tapered screw head end aligned with the threaded shaft;

FIG. 11: is a perspective view of an exemplary embodiment of the present inventive fastener showing disassembly of the fastener using two tools from the head end of the fastener;

FIG. 12A: is a side view of an exemplary embodiment of the present inventive fastener showing exemplary tools for disassembly of the fastener;

FIG. 12B: is a further side view of an exemplary embodiment of the present inventive fastener showing exemplary tools for disassembly of the fastener;

FIG. 13: is a perspective view of an exemplary embodiment of the present inventive fastener showing another exemplary embodiment of a combination of tools used to disassemble the fastener from one end;

FIG. 14: is a side view of an exemplary embodiment of the present inventive fastener showing another exemplary embodiment of a combination of tools to disassemble the fastener from one end as also shown in FIG. 13;

FIG. 15: is a side view of an exemplary embodiment of the present inventive fastener head end showing a gasket element included with the head end; and

FIG. 16: is a side view of an exemplary embodiment of the present inventive fastener showing disassembly of the fastener with a gasket demerit included with the head end,.

### DETAILED DESCRIPTION OF CERTAIN PREFERRED EMBODIMENTS

The following provides a disclosure, of an inventive fastener having a removable head end, such that the fastener may be disassembled without access to the opposite or nut end of the fastener. Such disassembly is through use of one or two tools engaging both a fastener tool element distinct from a tool element of the head end. More particularly, the fastener features a detachable or removable “head” that allows teach of the fastener without access to a nut engaged on the opposite end of the fastener. The utility of such a disassembly process is particularly relevant if the fastener is used and assembled such that the fastener nut is inaccessible to the user once fully assembled as part of an assembly, project, or device. The removable fastener head may be, in several embodiments, fashioned similar to a conventional nut except that it allows the screw or bolt of the fastener to be held stationary while unscrewing the head. Alternatively the fastener head may be held stationary while the serer or bolt is releasably rotated.

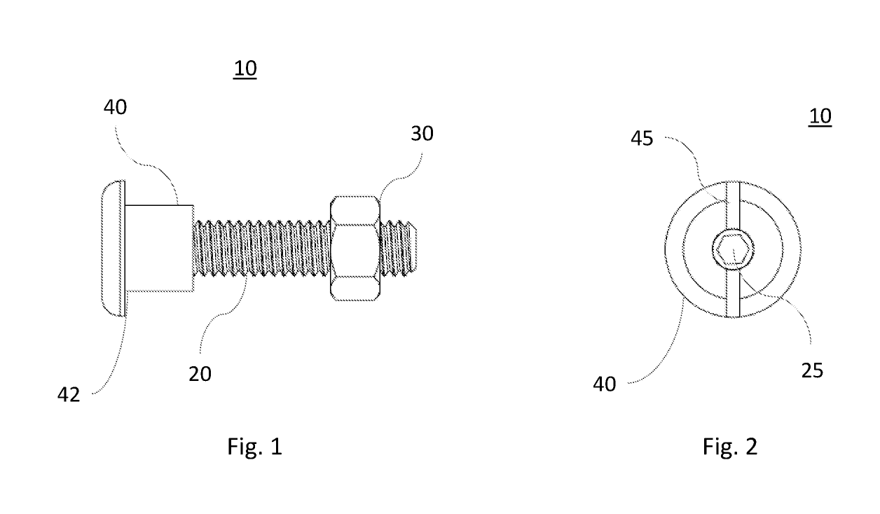

In more specific detail, in one embodiment as shown in FIGS. 1, 2, 3A, 3B, and 3C the fastener 10 comprises a threaded or partially threaded shaft 20 that includes (a) at one end a first tool receptacle feature 25 that allows for a tool to engage the threaded shaft 20, and (b) at the same end of the threaded shaft 20, a reducing end feature 22 for indexing into an annular end 42 of a nut-like head 40 with the head 40 having a second tool receptacle feature 45. The head end 40 is designed to allow access to the indexed threaded shaft 20 and the tool receptacle feature 25 when the head 40 is assembled on the threaded shaft 20 as shown in FIG. 2. Once assembled, the inventive fastener 10 resembles a normal screw or bolt with a widened head that can rest on a surface adjacent to a hole, and a long threaded shrift 20 that can accept a nut 30, as shown in FIG. 1, at the opposite end of the fastener shaft 20.

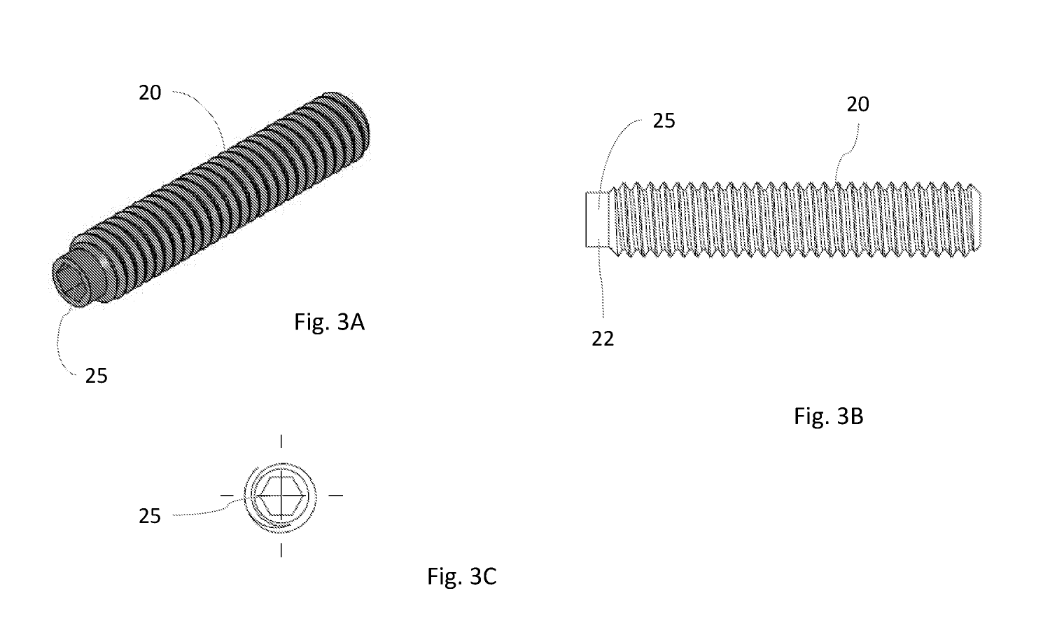

The tool receptacle feature on the head end 45, as shown in embodiment detailed Figs. I and 2, has a regular screwdriver slot, while the receptacle feature on the threaded shaft 25 shown in FIGS. 2, 3A, 3B, and 3C has a hex or Allen-wrench section. These are but two examples of acceptable and effective tool receptacle features. Other alternative embodiments can be manufactured to include a multitude of different tool receptacle designs including slotted, hexagonal, ton/spline, square, cross, and many others which can be readily and interchangeably paired for use as part of the fastener 10. For example, FIGS. 3A, 3B, and 3C show an exemplary embodiment of the fastener threaded shaft 20 with a hex tool receptacle feature 25, but could equally be manufactured and configured with a torqspline, square, cross, Philips head, or other tool receptacle element.

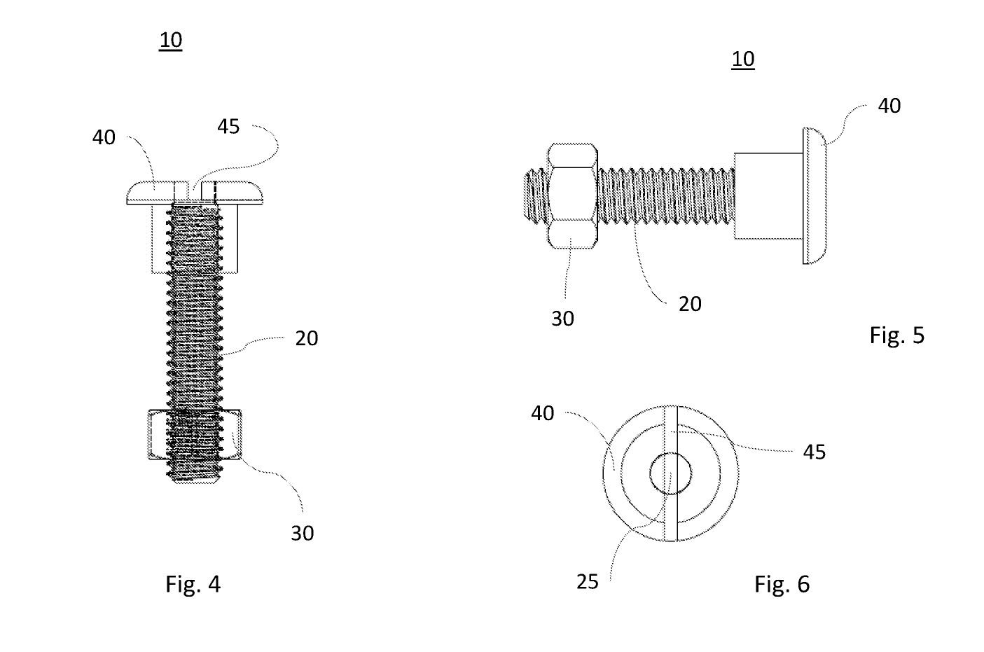

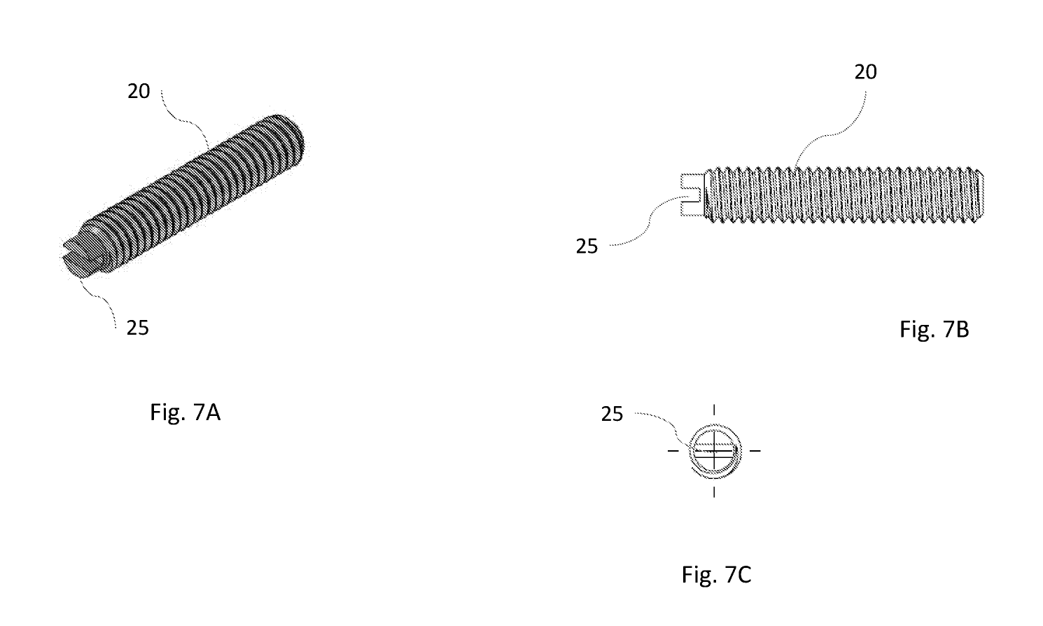

In another embodiment, FIGS. 4, 5, and 6 show an exemplary embodiment of the fastener 10 with the threaded shaft 20 haying a slotted end tool receptacle feature 25. In this embodiment, as shown in FIGS. 4 and 6, once the shaft slotted end tool receptacle feature 25 is aligned with the head end tool receptacle feature 45, a single tool, such as a regular screwdriver may be used to apply a tightening or loosening torque to both the shaft 20 and the head end 40. FIGS. 7A, 7B, and 7C show an exemplary embodiment of the fastener threaded shaft 20 with the slotted tool receptacle feature 25 as also shown in FIGS. 4, 5, and 6.

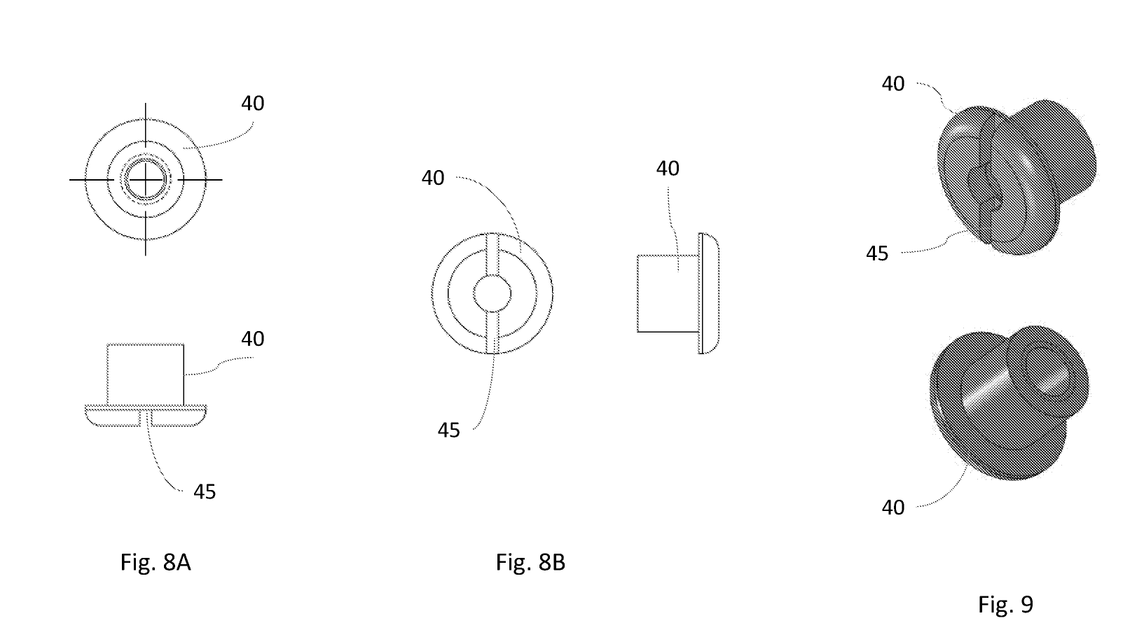

FIGS. 8A and 8B show in further detail an embodiment of a head end 40 having a slot as a tool receptacle feature 45. The embodiment of the head end 40 shown in FIGS. 8A and 8B may be used with different threaded shafts 20. More particularly, as shown in FIGS. 1, 4, and 5, the same head end 40 may be used with a shaft 20 that has a hex-shaped tool receptacle feature 25, as shown in FIG. 1, or may be used with a shaft 20 that has a slotted tool receptacle feature 25, as shown in FIG. 4. FIG. 9 shows a rendered illustration of an embodiment of the head end 40 also shown in FIGS. 8A and 8B.

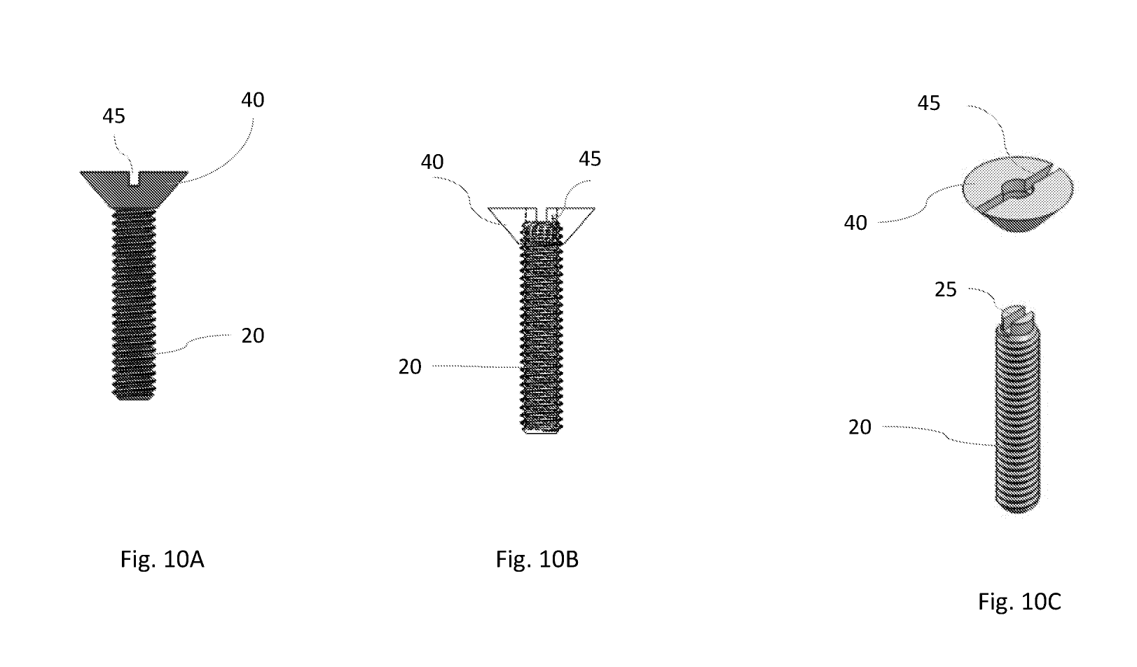

While the head end 40 may be manufactured with a relatively low-profile shape, as shown in FIGS. 8A, 8B, and 9, other shapes for the head end are equally applicable and workable. For example, the head end 40 may be shaped as a hex similar to a traditional lag bolt, and thereby having the tool receptacle feature 45 be engaged by an open-end wrench or similar tool, As shown in FIGS. 10A through 10C, another shape for the head end 40 could be similar to a tapered metal or wood screw have a slot tool receptacle feature 25. In this configuration, as described above, once the slot of the tapered screw head end 40 is aligned with a slot tool receptacle feature 25 of the shaft 20, as shown in FIG. 10B, a single tool, such as a slotted screwdriver could be used to engage the tool receptacle features 25 and 45, and simultaneously rotate the shaft 20 and head end 40 to assemble or disassemble the fastener 10.

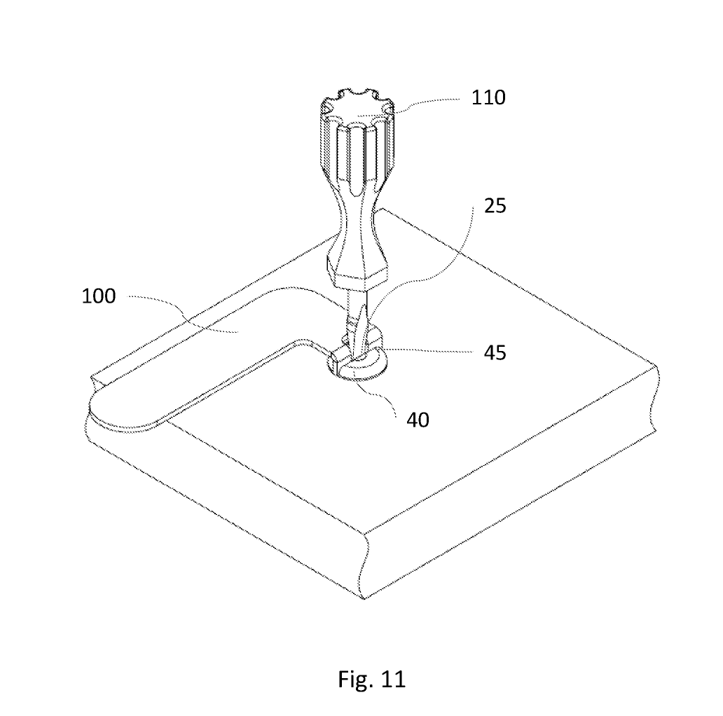

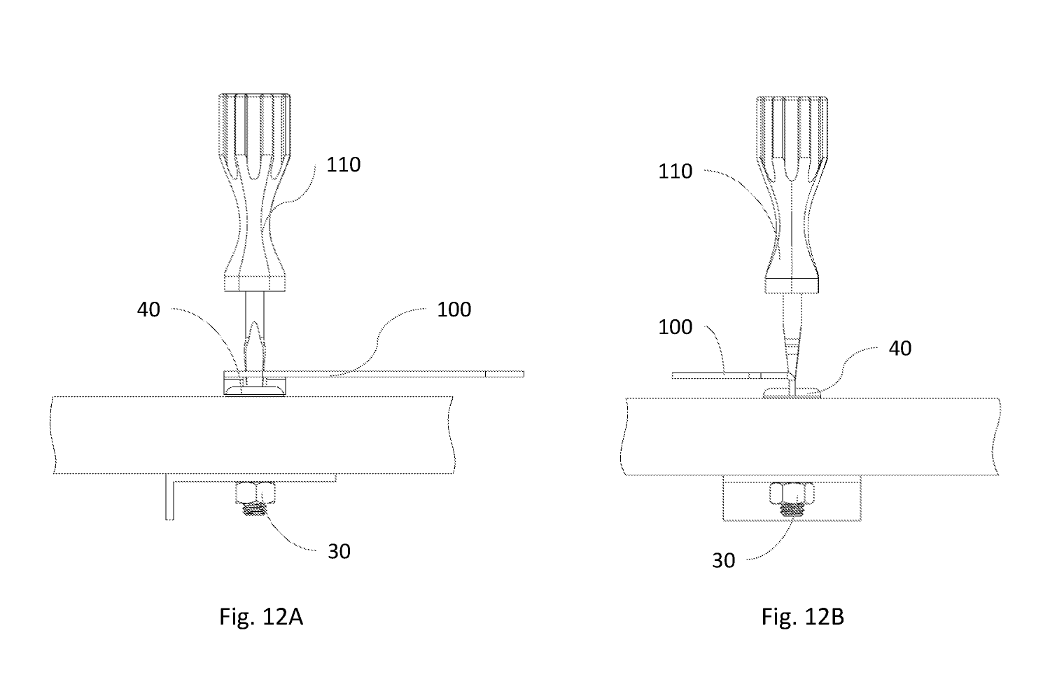

To illustrate usage and operation of the fastener 10 design, in one embodiment shown in FIG. 11, the fastener 10 may be disassembled from the head end of the fastener using two tools. As illustrated, the head end 40 is held in place by a slotted tool 100 engaging the head end tool receptacle feature 45, while the shall 20 may be loosened using screwdriver Ii 0 engaging the tool receptacle feature 25. FIGS. 12A and 12B show two different side views of the two tools 100 and 110 engaging their respective tool receptacle features 25, 45 formed in the shaft 20 and bead end 40. As described above, for the slotted tool receptacle features 25, 45, once the features are aligned or indexed, a single tool or screwdriver may be used to apply a tightening torque to the fastener. More particularly for assembly, certain tool receptacle features on both the head. and threaded rod may be aligned such that a single normal hand tool (e.g., screwdriver) may be used to install the fastener by applying a torque or holding force to both the head end and the threaded shaft simultaneously with the single tool.

To disassemble the head end 40 from the threaded shaft 20, as illustrated in FIG. 11, a tool 110, a screwdriver in this example, is inserted into the tool receptacle 25 on the top of the threaded shaft 20, and a second annular tool 100, such as a slotted wrench, is inserted into the receptacle feature on the head 45. By turning the two tools, being the screwdriver and the slotted wrench, in opposite directions the threads of the fastener loosen and the parts disassemble. Alternatively one of the two tools could be held stationary while the other tool is rotated allowing the user to disassemble the fastener 10 without having access to both ends of the fastener 10. While a screwdriver is shown in FIGS. 11, 12A, and 12B, as noted above, different tools may be used to engage the shaft 20, such as a hex wrench (open--end or closed-end) or a torqspline wrench.

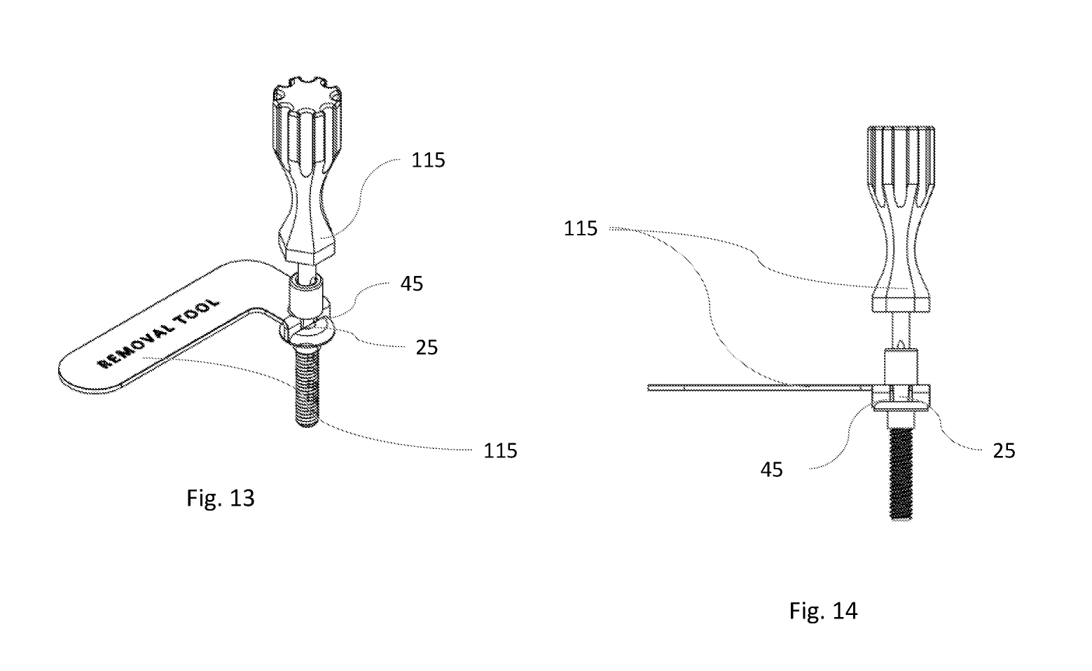

In another embodiment, a single tool, or combination of tools 115, as shown in FIGS. 13 and 14, may be fashioned that includes elements to both engage the threaded shaft 20 tool receptacle 25 as well as engage the head end 40 tool receptacle 45. This configuration of a combination of tools has the screwdriver fitting into a socket element fashioned in the slotted wench tool, where the slotted wrench engages the head end tool receptacle 45. Another example of such a tool 115, not shown, could incorporate a hex element to engage a hex tool receptacle 25 in the threaded shaft, as well as a spaced slotted screwdriver to engage spaced slots (tool receptacle) within the head end 40.

The production of all parts for the inventive fastener may use familiar and well known manufacturing techniques for conventional nuts and bolts, thereby allowing for efficient and economical manufacturing processing. For example, a conventional screw or bolt is most commonly cold forged from a cylindrical blank where the head is first shaped by a series of forging dies and is then threaded by a thread rolling machine. Using very similar production steps, the threaded shaft from this invention may he formed from a cylindrical blank that is first necked down on one end by a series of dies, which can also readily incorporate the step of adding the tool receiving feature at one end of the fastener shaft, file fastener shaft may be then threaded, or partially threaded, by a thread rolling machine.

Further, a conventional nut is typically hot or cold forged and then cooled and threaded by a thread cutting tap. In a similar fashion, the threaded head for embodiments of the inventive fastener may be hot or cold forged (or cast, depending on material used) and then threaded by a thread cutting tap.

The three described elements of the inventive fastener 10, being the shaft 20, head end 40 and nut end 30, are the basic and most necessary components of the inventive fastener 10, Additional components, to add further features and utility to the fastener may include a locking mechanism such as a locknut or nylon insert incorporated into the head, end that would serve to prevent the two pieces from loosening or releasing prematurely due to vibration, shock, or normal wear and tear. Alternatively, a nylon or locking material may be incorporated into the threaded section of the shaft 20 to similarly prevent the shaft 20 and head end 40 from releasing prematurely due to vibration. Such additional mechanisms may, however, in certain uses increase the cost of the device, and possibly increase difficulty in the disassembly process. Particular applications, including the need to address vibratory environments, will typically dictate whether such elements and features are necessary.

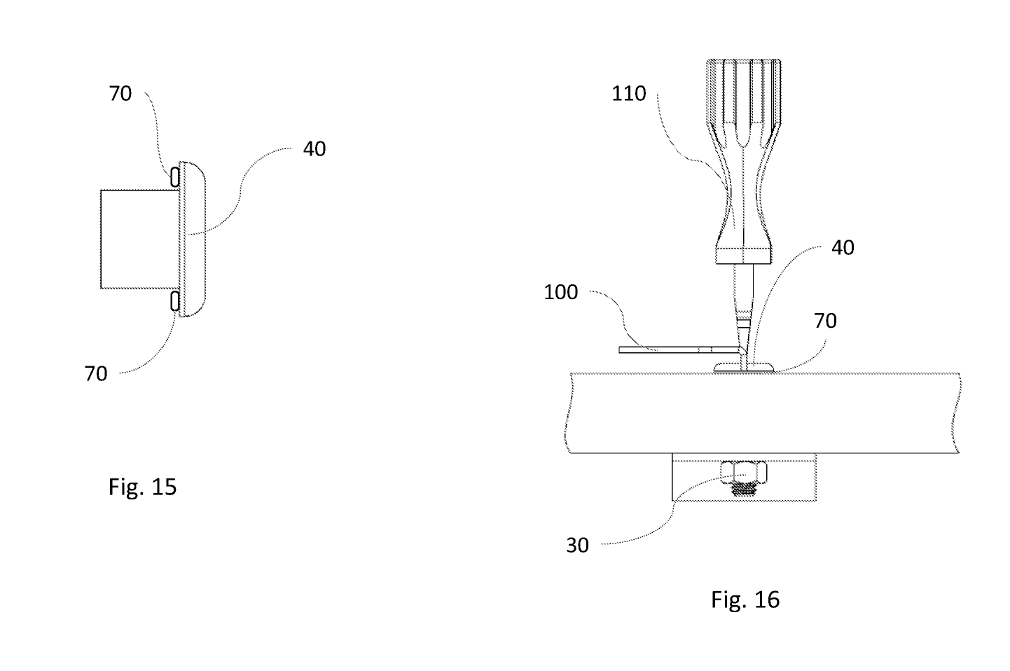

In still another preferred embodiment, shown in FIGS. 15 and 16, the head end may also have a gasket element 70, such that when assembled (as shown in FIG. 16) with the threaded shaft 20, the head and shaft forms a sealed junction so that fluids such as water, gases, or air will not permeate the mounting surface through the screw or leak through the fastener elements. Other features that may be incorporated as part of the fastener 10 for safety and aesthetics reasons, include using a low profile head 40 and or a smooth radii head, as shown in FIGS. 8A and 12A, which are common to many typical screw heads.

While preferred embodiments of the inventive methods and systems have been described and disclosed, in particular by reference to certain figures and exemplary embodiments relating to bolt-type fasteners, such type of fasteners and bolts are not to be construed as limiting the scope of application of the inventive devices or products. For example, alternative head ends, retaining ends, and alternative tool-accepting sections could be incorporated into the fastener device to provide other tool applications that may be effectively used with a variety of removable head end fasteners.

It will be recognized by those skilled in the art that other modifications, substitutions, and/or other applications are possible and all such modifications, substitutions and applications are within the true scope and spirit of the present invention. It is likewise understood that the above disclosure and attached claims are intended to cover all such modifications, substitutions, and/or applications.

What is claimed is:

1. A fastener having a removable head end, comprising:
a. an at least partially threaded shaft having two ends, wherein a first end has a tool receptacle accepting section, and a second end can accept a retaining clement;
b. a head end having a hole therein, a tool receptacle accepting section, and a shaft engaging section, such that upon engaging said head end shaft engaging section onto said first end of said threaded shaft, said shaft tool receptacle accepting section is accessible through said hole; and
c. a retaining element having a threaded hole therein for engagement and screwing onto said second end of said threaded shaft.

2. A fastener having a removable head end, comprising:
a. a fully threaded shaft having two ends, wherein a first end has a tool receptacle accepting section, and a second end can accept a retaining element;
b. a head end having a hole therein, and a threaded section, such that upon screwing ad head end threaded section onto said, first end of said threaded shaft, said shaft tool receptacle accepting section indexes into, and is accessible through said link, said head end further having a tool receptacle accepting section; and
c. a retaining element having a threaded hole therein for engagement and screwing onto said second end of said threaded shaft.

3. The fastener having a removable head end, as in claim 1, wherein said retaining element is a nut.

4. The fastener having a removable head end, as in claim 1, wherein said head end has a low-profile shape.

5. The fastener having a removable head end, as in claim 1, wherein said head end has a hex-shape.

6. The fastener having a removable head end, as in claim 1, farther comprising a locking mechanism to increase friction between said head end and said threaded shall to inhibit inadvertent disassembly of said fastener due to vibration.

7. The fastener having a removable head end, as in claim 6, wherein said locking mechanism is a nylon insert incorporated into said head end.

8. The fastener having a removable head end, as in claim 6, wherein said locking mechanism is a nylon insert incorporated onto at least one end of said threaded shaft.

9. The fastener having a removable head end, as in claim 1, further comprising a gasket element for creating a fluid-tight seal when said fastener is assembled and installed.

10. The fastener having a removable head end, as in claim 9, wherein said gasket element is incorporated into said head end.

11. The fastener having a removable head end, as in claim 9, wherein said removable head end engages said first end of said threaded shaft to form a water-tight seal between said removable head and said threaded shaft.

12. The fastener having removable head end, as in claim 1, wherein said head end is low-profile bolt head having a slotted screwdriver accepting, section.

13. The fastener having a removable bead end, as in claim 1, wherein said retaining element is a hex-shaped bolt end.

14. The fastener having a removable head end, as in claim 1, wherein said shaft tool receptacle accepting section accepts an Allen wrench.

15. The fastener having a removable head end, as in claim 1, wherein said shaft tool receptacle accepting section accepts a torx tool.

16. The fastener having a removable head end, as in claim 1, wherein said shaft tool receptacle accepting section accepts a slotted screwdriver.

17. The fastener having a removable head end, as in claim 1, wherein said head end tool receptacle accepting section accepts a slotted screwdriver.

18. The fastener having a removable head end, as in claim 1, wherein said head end fully engages said threaded shaft through an approximate 180-degree rotation.

19. A threaded fastener and tool system, for use in assembling and disassembling a threaded fastener, comprising:
a. a threaded shaft having two ends, wherein a first end has a first tool receptacle accepting section, and a second end can accept a retaining element;
b. a head end having a hole therein, and a shaft engaging section, such that upon engaging said head cod engaging section onto said first end of said threaded shaft, said shaft tool receptacle accepting section indexes into, and is accessible through said hole, said head end further having a second tool receptacle accepting section;
c. a retaining element having a threaded hole therein ⁻for engagement and screwing onto said second end of said threaded shaft;
d. a first tool for applying rotational torque to said threaded shaft via said first tool receptacle accepting section of said threaded shaft and engaging said first tool receptacle accepting section through said hole in said head end; and
e. a second tool for applying rotational torque to said head end via said second tool receptacle accepting section of said head end.

20. The fastener having a removable head end, as in claim 19, wherein said first tool and second tool are incorporated into a single device.

21. The fastener having a removable head end, as in claim 19, wherein said head end fully engages said threaded shaft by an approximate 180-degree rotation.
